(19) United States
(12) Patent Application Publication
(10) Pub. No.: US 2006/0064408 A1
(43) Pub. Date: Mar. 23, 2006

(54) Program, method and apparatus for database management, and recording medium

(75) Inventors: Hisayuki Enbutsu, Kawasaki (JP); Mitsuhide Nishino, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/062,477

(22) Filed: Feb. 22, 2005

(30) Foreign Application Priority Data
Sep. 17, 2004 (JP) 2004-271074

(51) Int. Cl. G06F 17/30

(52) U.S. Cl. 707/3

(57) ABSTRACT

An edition number management unit manages an edition number management table to which an edition number is registered for each page which is a minimum unit for exclusively controlling a basic database, and updates the relevant edition number in the edition number management table in accordance with update processing of a page. When receiving a search processing request, a search processing unit executes search processing of the basic database, notifies an AI server, which is a search-processing request source, of search results, and notifies the AI server of edition numbers of the searched pages for storage. When receiving a record update processing request based on the notification of the search results, an update processing unit compares edition numbers at the time of the search obtained from the AI server with current edition numbers obtained from the edition number management table, updates the basic database if the both edition numbers are identical and notifies of an error for a retry from the search process if the both edition numbers are not identical.

### CROSS-REFERENCE TO RELATED APPLICATION

This application claims the benefit of priority from prior application No. JP 2004-271074, filed Sep. 17, 2004, in Japan.

### BACKGROUND OF THE INVENTION

1. Field of the Invention

The present invention relates generally to a program, method, apparatus and recording medium for the management of a database, adapted to receive a processing request for search and update from an application on a server to access a host basic database, and, more particularly, to a program, method apparatus and recording medium for managing a database, adapted to receive and process an update request for updating a portion of searched data after notifying of the search results.

2. Description of the Related Arts

Conventionally, in a management method of a host basic database, a database management program referred to as a database connector is provided for accessing to the host basic database from an application on a server. In the management program of such a host basic database, if an update is performed for a portion of records searched by the application on the server, the search and update are executed as one (1) transaction. When receiving a collective search processing request such as an all-entry search or a key-value prefix search from the application on the server first, the management program of the host basic database starts a transaction of the search processing and notifies the server of a retrieved record obtained as a search result. When starting the transaction of the search processing, an exclusive lock is set to a page area to be searched to prevent the contents from being changed by other transactions in the middle of the processing. When receiving the notification of the retrieved record from the host, the application on the server displays the retrieved record, and an operator watches the retrieved record, performs input operations for changing the record contents and then request a record update to the host. Responding to this, the host database management program updates the basic database with the updated record received from the server, terminates a transaction and releases the exclusive lock when the update completes.

However, in such a conventional database management program, if a portion of retrieved records is updated after a search, an exclusive lock is set to and occupies a page area of a database until a transaction completes and, moreover, since an update request has a time lag on the order of minutes because of accompanying operations of an operator, a large number of pages are occupied in a basic database for a long time until the transaction completes, so that other processing has to wait for occupation during that period and a problem is posed as a decreasing multiplicity of the executions of the search and update to the basic database. In order to prevent a large number of pages being occupied for a long time, the search processing and the update processing of the database may be executed in different transactions. However, since the exclusive lock is released between the search processing and the update processing, it is needed to confirm that the contents of the update-target records have not been modified due to other transactions during a period from termination of the search processing to initiation of the update processing. For this confirmation, a large amount of data obtained by the collective search must be stored on the server side by acquiring a storage area, and logic must be added to the application of the server for comparing the update-target records with the search-time records stored in the server to confirm that the records has not been modified due to other transaction, at the time of the update. However, addition of such logic requires modification of all the applications which exist in large numbers and also requires acquisition of the storage area on the server side for storing a large amount of data obtained by the collective search, and a problem is posed because this is impractical.

### SUMMARY OF THE INVENTION

According to the present invention there is provided a database management program, method, apparatus and recording medium for performing the search processing and the update processing of the database in different transactions to reduce the occupation time and to minimize the occupied range of the database for the update processing, without requiring modification of applications and acquisition of a large storage area. The database management program of the present invention is a program operable to drive a host computer constituting a host to execute:

an edition number management step of registering and managing an edition number of each minimum unit for exclusively controlling the database, and updating the corresponding edition number in accordance with updating processing within the minimum unit;

a search step of executing database search processing when a search processing request for the database is received, notifying a search-processing request source of search results, and notifying the search-processing request source of edition numbers of the minimum units corresponding to all the search results for storage; and

an update step of, when a database update-processing request is received based on the notification of the search results, comparing edition numbers at the time of the search obtained from the update-processing request source with current edition numbers managed by the edition number management step, updating the database if the both edition numbers are identical and notifying of an error if the both edition numbers are not identical.

The minimum unit for exclusively controlling the database is a page unit including multiple records, and the edition number management step registers and manages the edition number of each page for exclusively controlling the database and updates the corresponding edition number in accordance with the record update processing within the page, wherein the search step executes the database search processing when a record search request for the database is received, notifies the request source of search results, and notifies the request source of edition numbers of the pages corresponding to the retrieved records for storage, and wherein when a record update request is received based on the notification of the retrieved records, the update step compares edition numbers at the time of the search obtained from the update request source with current edition numbers managed by the edition number management step, updates the database if the both edition numbers are identical and notifies of an error if the both edition numbers are not identical. The search step sets an exclusive lock to a search-target area of the database specified by a minimum unit of the exclusive control when the search is initiated and releases the exclusive lock when the search is terminated, and wherein the update step sets an exclusive lock to a update-target area of the database which is a minimum unit of the exclusive control including update-target data when the update is initiated and releases the exclusive lock when the update is terminated. The update step receives the database update-processing request after a time lag due to human operations from the notification of the search results. The edition number management step sets an initial value of an edition number for each minimum unit controlled exclusively, targeting a database area allocated to the search request source, and increments the edition number by 1 every time the update processing is performed. As the error notification, the search step notifies of a retry request from the search processing. The database is a basic database of the host, and the request source of the search processing and of the update processing is an application on a server.

The present invention provides a database management method. The database management method of the present invention comprises:

an edition number management step of registering and managing an edition number of each minimum unit for exclusively controlling the database, and updating the corresponding edition number in accordance with updating processing within the minimum unit;

a search step of executing database search processing when a search processing request for the database is received, notifying a search-processing request source of search results, and notifying the search-processing request source of edition numbers of the minimum units corresponding to all the search results for storage; and

an update step of, when a database update-processing request is received based on the notification of the search results, comparing edition numbers at the time of the search obtained from the update-processing request source with current edition numbers managed by the edition number management step, updating the database if the both edition numbers are identical and notifying of an error if the both edition numbers are not identical.

The present invention provides a database management apparatus. The database management apparatus of the present invention comprises:

an edition number management unit registering and managing an edition number of each minimum unit for exclusively controlling the database, and updating the corresponding edition number in accordance with updating processing within the minimum unit;

a search unit executing database search processing when a search processing request for the database is received, notifying a search-processing request source of search results, and notifying the search-processing request source of edition numbers of the minimum units corresponding to all the search results for storage; and

an update unit, when a database update-processing request is received based on the notification of the search results, comparing edition numbers at the time of the search obtained from the update-processing request source with current edition numbers managed by the edition number management step, updating the database if the both edition numbers are identical and notifying of an error if the both edition numbers are not identical.

The present invention further provides a computer readable recording medium having a database management program stored therein. The recording medium of the present invention stores a database management program operable to drive a computer managing a database to execute:

an edition number management step of registering and managing an edition number of each minimum unit for exclusively controlling the database, and updating the corresponding edition number in accordance with updating processing within the minimum unit;

a search step of executing database search processing when a search processing request for the database is received, notifying a search-processing request source of search results, and notifying the search-processing request source of edition numbers of the minimum units corresponding to all the search results for storage; and

an update step of, when a database update-processing request is received based on the notification of the search results, comparing edition numbers at the time of the search obtained from the update-processing request source with current edition numbers managed by the edition number management step, updating the database if the both edition numbers are identical and notifying of an error if the both edition numbers are not identical.

The details of the database management method, apparatus and recording medium according to the present invention will become the same as those of the database management program of the present invention. According to the present invention, the execution multiplicity can be improved for database accesses by performing the search processing and the update processing to the database on the host side in different transactions, without modifying the applications on the server side. Specifically, although a time lag on the order of minutes exists between the search and the update because an operator performs editing operations for a portion of the retrieved records and requests the update processing, since the search processing and the update processing are performed in different transactions and the occupied database is released during the gap time between the search processing and the update processing, the database can be searched and updated with requests from other transactions and the execution multiplicity can be improved for the database accesses. Even if the search processing and the update processing are performed in different transactions, at the time of the update processing, a decision can be made whether the update-target data has been modified or not due to other transactions by managing edition numbers for each minimum unit of the exclusive lock to the database, for example, for each page, and by comparing the edition number at the time of the search with the edition number at the time of the update, so that it is not needed to acquire a storage area on the server side to store a large amount of data obtained as a search result for comparison, and it is only needed to store the edition numbers of the searched page, which are a small amount of data. Although, in addition to the existing search and update requests, the application stores edition-number information from the host at the time of the search and responds to readout from the host with the edition-number information at the time of the update, since this is merely an input/output function of the application, the application is not needed to be modified. Further, at the time of the update processing, by exclusively locking and occupying a minimum unit including the update-target data, the occupied area is localized to the requisite minimum at the time of the update processing, and an execution multiplicity can be improved for database accesses of other transactions in the update processing. The above and other objects, features and advantages of the present invention will become more apparent from the following detailed description with reference to the drawings.

### BRIEF DESCRIPTION OF THE DRAWINGS

FIG. 1 is a block diagram of a functional structure of database management processing of the present invention;

FIG. 2 is an explanatory view of a page structure in a basic database of FIG. 1;

FIG. 3 is an explanatory view of an edition number Management table of FIG. 1;

FIG. 4 is an explanatory view of an exclusive management table used in exclusive lock control of FIG. 1;

FIG. 5A is a time chart of database management processing accompanied by edition number management in host and server, according to the present invention;

FIGS. 5B and 5C are time charts of database management processing continued from FIG. 5A;

FIGS. 6A and 6B are explanatory views of a specific example of an edition number storage table on the server side and an edition number management table on the host side at the time of update;

FIG. 7 is a flowchart of database management processing according to the present invention; and

FIG. 8 is a flowchart of database management processing continued from FIG. 7.

### DETAILED DESCRIPTION OF THE PREFERRED EMBODIMENT

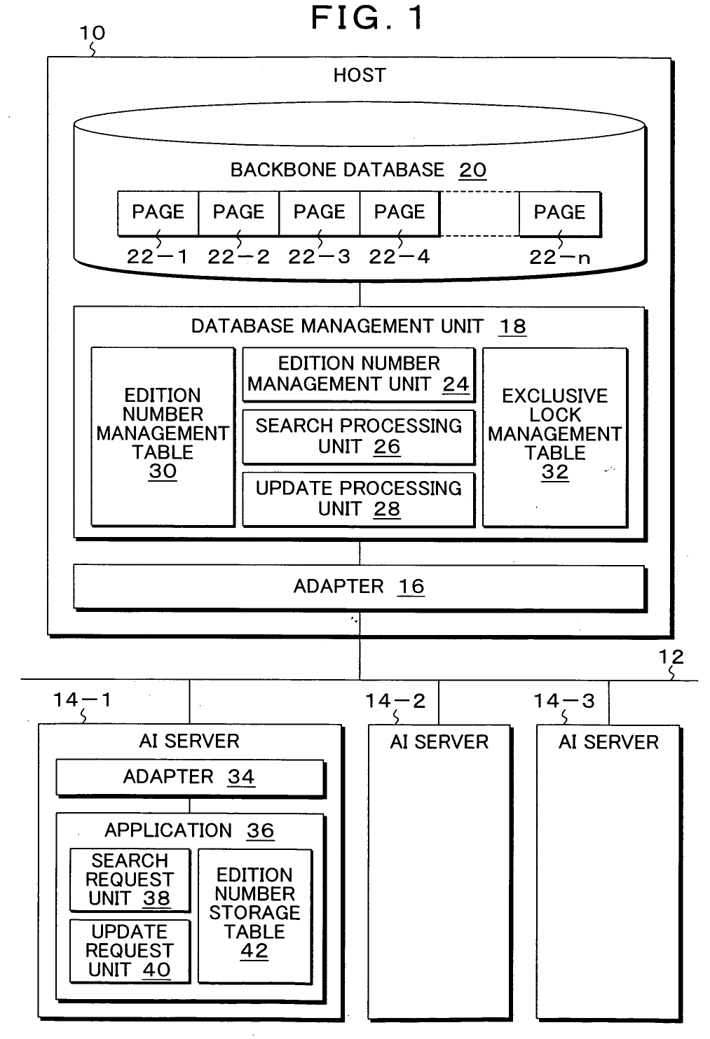

FIG. 1 is a block diagram of a functional structure of database management processing according to the present invention. In FIG. 1, a host 10 is connected with, for example, UNIX® AI servers 14-1, 14-2 and 14-3 via a network 12. The host 10 is provided with an adapter 16, a database management unit 18 acting as a database connector, and a basic database 20. The basic database 20 is constructed as a database storing core operation data in a corporation or the like where the host 10 is installed. Areas of the basic database accessed by the AI servers 14-1 to 14-3 are allocated by initial setting depending on each application. In the host 10 of FIG. 1, pages 22-1 to 22-n of the basic database 20 indicate page areas allocated to applications of the AI servers 14-1 to 14-3 as access targets.

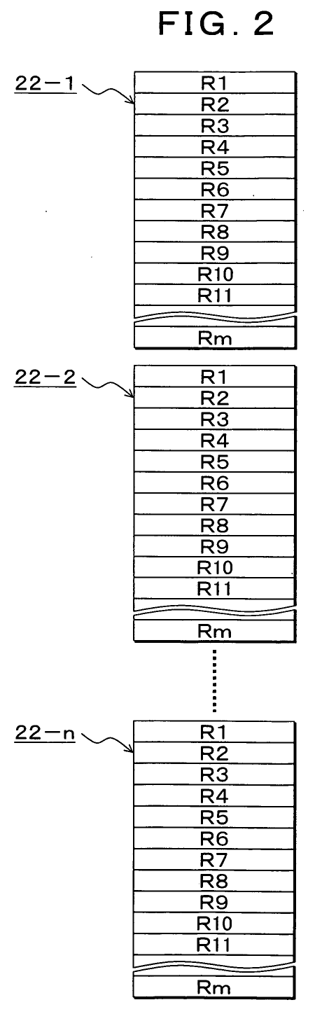

The pages 22-1 to 22-n of the basic database 20 has a structure taken out and shown in FIG. 2. In FIG. 2, records R1 to Rm constitutes each of the pages 22-1 to 22-n of the basic database 20 which are the access targets of the AI servers 14-1 to 14-3, and a search and an update are performed for each record. If a search request is received from the AI servers 14-1 to 14-3, after an exclusive lock is applied to the pages 22-1 to 22-n which is the access-target area, the search processing is performed. Also, if a portion of the retrieved records must be updated after the search, the update processing of the record is performed with the exclusive lock being applied to the page including the update-target record. Referring to FIG. 1 again, the database management unit 18 of the host 10 is provided with an edition number management unit 24, a search processing unit 26, an update processing unit 28, an edition number management table 30 and an exclusive lock management table 32. The database management unit 18 acts as a database connector on the host 10 side enabling the AI servers 14-1 to 14-3 to access the basic database 20. The edition number management unit 24 of the database management unit 18 manages the edition number management table 30 to which the edition number is registered for each page, i.e., a minimum unit of exclusive control in the basic database 20, and updates the edition number of a corresponding page in accordance with the update processing of a record in the page.

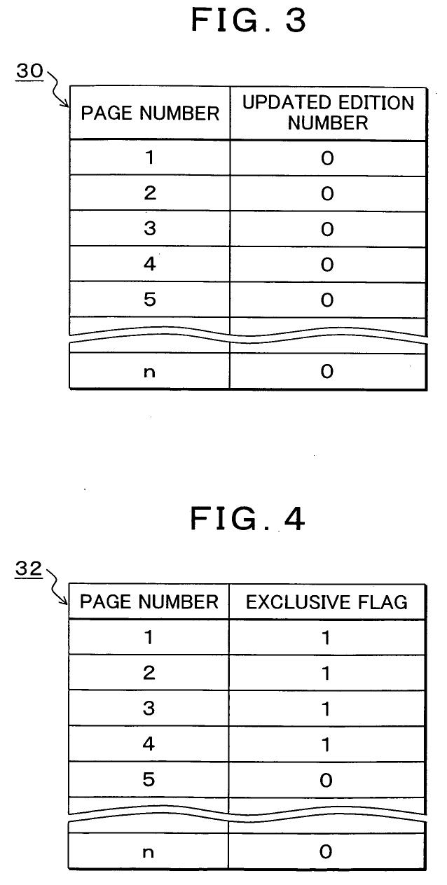

FIG. 3 is an explanatory view of the edition number management table 30 provided in the database management unit 18 of FIG. 1. The edition number management table 30 of FIG. 3 consists of two (2) items which are “page number” and “updated edition number”; when a job is started in the database management unit 18, the edition number management table 30 as shown in FIG. 3 is disposed after acquiring an area for managing the updated edition numbers in a common section of the memory of the host 10; and the updated edition number is set to 0 as an initial value as shown and is incremented by +1 every time a record in the page is updated. Referring to FIG. 1 again, corresponding to the database management unit 18 acting as a database connecter of the host 10, an adapter 34 and an application 36 is provided on the AI server 14-1 side, and the application 36 is provided with a search request unit 38, an update request unit 40 and an edition number storage table 42. This structure of the AI server 14-1 is the same as other AI servers 14-2 and 14-3. When receiving the a request for the record search through the basic database 20 using a collective search, which is an all-entry search or a key-value prefix search, from search request unit 38 provided in the application 36 of the AI server 14-1 for example, the search processing unit 26 provided in the database management unit 18 of the host 10 performs the search processing though pages 22-1 to 22-n which make up the target-page area in the basic database 20 and notifies the request-source AI server 14-1 of retrieved records. At the time of the search processing of the search processing unit 26, the search processing is performed after an exclusive lock is applied in order to prohibit other AI servers 14-2 and 14-3 from accessing the pages 22-1 to 22-n of the basic database 20. The exclusive lock to the pages 22-1 to 22-n is applied by setting an exclusive flag to the exclusive lock management table 32.

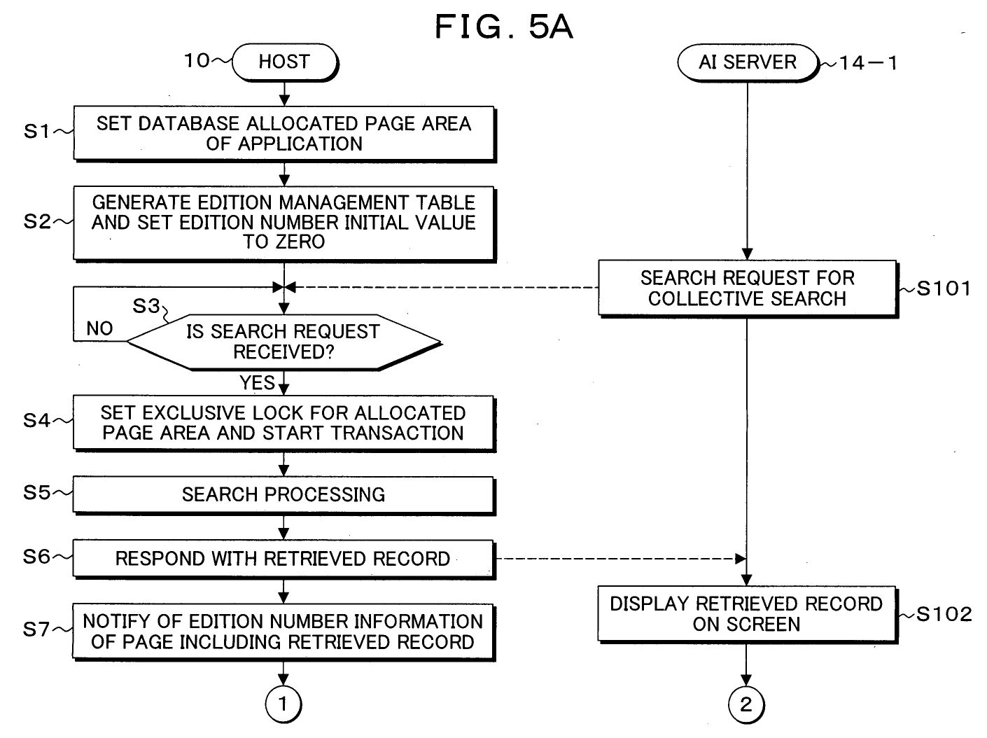

FIG. 4 is an explanatory view of the exclusive lock management table 32 of FIG. 1. In the exclusive lock management table 32 of FIG. 4, an “exclusive flag” is provided corresponding to a “page number”, and by setting the “exclusive flag” to 1, the exclusive lock can be applied to occupy the target page. Referring to FIG. 1 again, by performing the search processing, the search processing unit 26 provided in the database management unit 18 of the host 10 notifies the request-source AI server 14-1 of retrieved records and also obtains an edition number of the page corresponding to the retrieved records from the edition number management table 30 to notifies the request-source AI server 14-1 of the edition number which is stored in the edition number storage table 42 provided in the application 36. In the such search processing of the search processing unit 26 in the database management unit 18 of the host 10, after a transaction is started in response to a search request and the notification of the retrieved records is performed for storing the edition number, the transaction is terminated, and the termination of the transaction resets the exclusive flag (FIG. 4) in the exclusive lock management table 32 to zero to release the exclusive lock. When notified of the retrieved record from the host 10, the application 36 of the AI server 14-1 displays the retrieved records on a display for presentation to an operator, and the operator reviews the retrieved records to decides whether the contents of the retrieved records should be modified or not, performs required editing operations such as modification, deletion and addition of the contents of the retrieved records if needed and then performs input operations for a record update request. In the processing for updating a portion of the retrieved records based on such retrieved records, because the editing operation of the operator intervenes, a time lag on the order of minutes is typically generated before the record update request is performed. However, in the database management unit 18 of the host 10, since the exclusive lock of the search-target pages 22-1 to 22-n is released by termination of the search of the search processing unit 26, other AI servers 14-2 and 14-3 can access the basic database 20 during the period between the termination of the search and the initiation of the update. The update request unit 40 performs a record update request to the host 10 in response to an update input instruction on the bases of the editing operations of the operator based on the retrieved record. When receiving the record update request from the AI server 14-1, the update processing unit 28 provided in the database management unit 18 of the host 10 obtains an edition number at the time of the search from the edition number storage table 42 by means of a read out request to the application 36 of the AI server 14-1, compares the obtained edition number at the time of the search with a current edition number obtained from the edition number management table 30 and performs the update processing for the target record in the target page if both edition numbers are identical. On the other hand, if the current edition number obtained from the edition number management table 30 is not identical to the edition number at the time of the search obtained from the AI server 14-1, this is the case that update processing of the update-target record has been performed and the edition number has been updated by an access from other AI servers 14-2 and 14-3 after terminating the search processing and before requesting the update processing, and the contents of the record has been changed from the time of the search. In this case, the AI server 14-1 is notified of an error indicating that the record can not be updated and the update processing is terminated. Also, when the update processing is initiated, the update processing unit 28 applies the exclusive lock for occupation by setting the exclusive flag of the exclusive lock management table 32 to 1 for the page including the update-target record and releases the exclusive lock by setting the exclusive flag to 0 to turn off when the update processing is terminated. Further, in the error notification to the AI server 14-1 when it is decided in the update processing unit 28 that the current edition number is not identical to the edition number at the time of the search, contents are included for requesting a retry from the search processing. When receiving the error notification of the update request, the AI server 14-1 cancels the search request and the update request covered by the error and then restarts the search request unit 38 to retry the search request of the basic database 20 to the host 10 again.

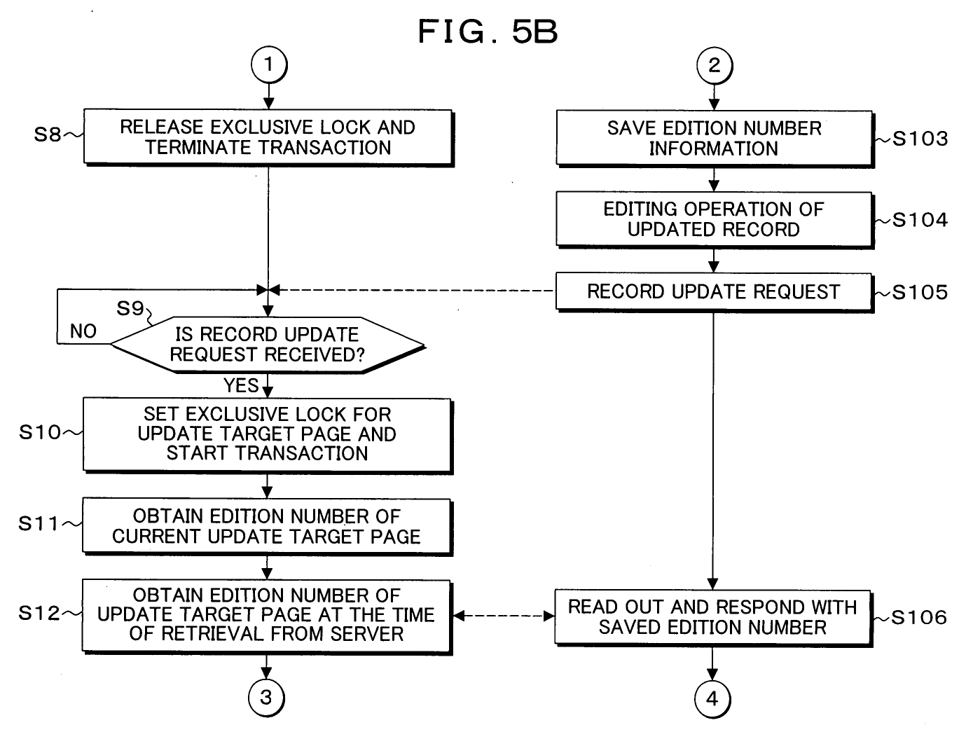

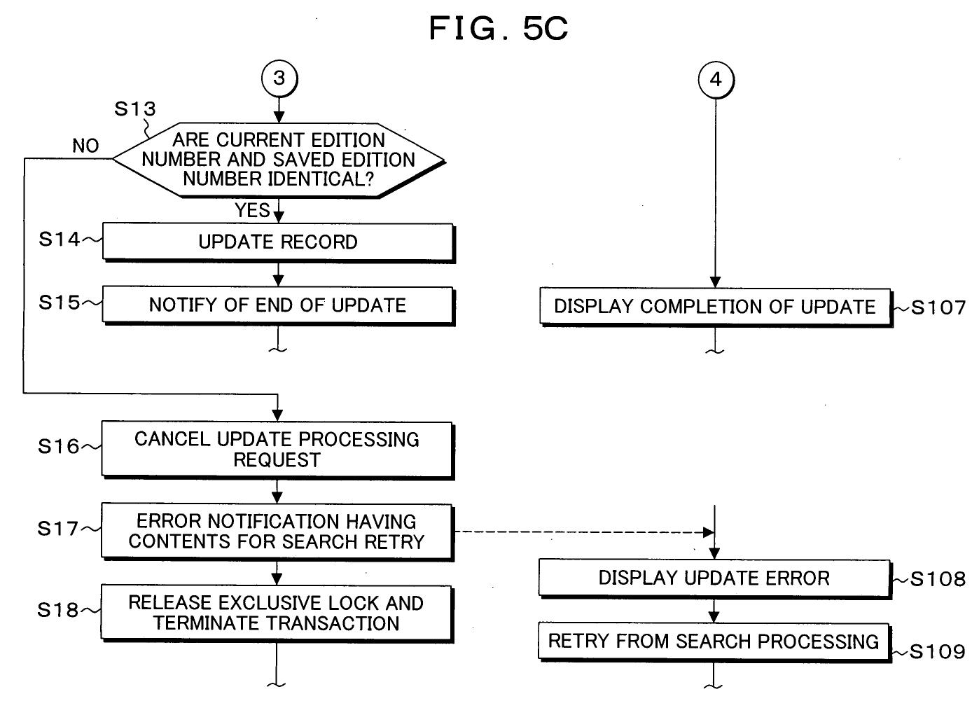

FIGS. 5A to 5C are time charts of database management processing accompanied by edition number management in the host 10 and the AI server 14-1 of FIG. 1. In FIG. 5A, when starting a job in the database management unit 18 acting as a database connector on the host side, the host 10 sets an database allocated page area for the application 36 of the AI server 14-1 in step S1. For example, this allocated page area is set as the area of the pages 22-1 to 22-n shown in FIG. 1. Subsequently, in step S2, the edition number management table 30 is generated for the allocated page area and initial values of the edition numbers are set to 0. In other words, the edition number management table 30 is held in the common section in the memory of the host 10 and initial values of the update edition numbers are set to 0 corresponding to the page numbers of the pages 22-1 to 22-n which are the allocated page area. Then, in step S3, it is checked whether a search request is received from the AI server 14-1 or not. In the AI server 14-1, if a search request of a collective search is performed in step S101, the search request is identified in step S3 and the operation proceeds to step S4, and an exclusive lock is set to the allocated pages 22-1 to 22-n to initiate a transaction. When the exclusive lock is set to the allocated pages 22-1 to 22-n, if the exclusive lock has been set by other transactions, after waiting for release of the exclusive lock, the own exclusive lock will be set. Subsequently, in step S5, the search processing is performed for the target pages 22-1 to 22-n based on the collective search request and, in step S6, the AI server 14-1 is responded with retrieved records. Then, in step S7, the AI server 14-1 is notified of edition-number information of pages including the retrieved records. For example, if the retrieved records are included in two (2) pages which are the pages 22-2 and 22-3 out of allocated pages 22-1 to 22-n, the AI server 14-1 is notified of update edition numbers of the pages 22-2 and 22-3. Then, in step S8, the exclusive lock is released and the transaction is terminated. On the other hand, after displaying the retrieved records on a screen in step S102, the AI server 14-1 receives and store into the edition number storage table 42 the edition-number information of the pages including the retrieved records notified from the host 10 in step S103.

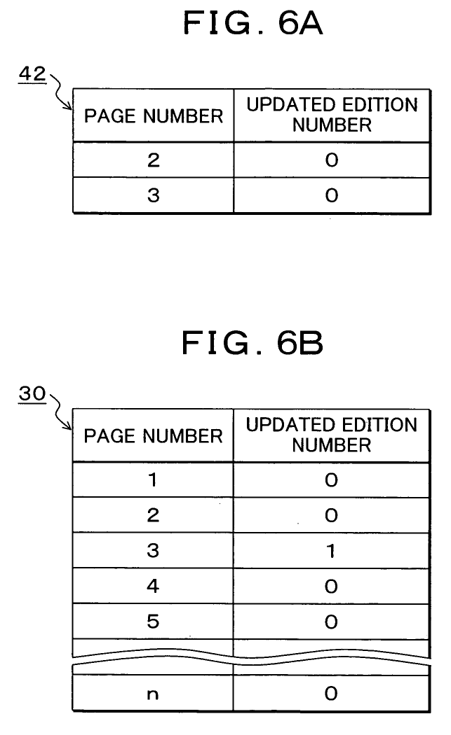

FIG. 6A shows stored contents of the edition number storage table 42 in the AI server 14-1 and the update edition numbers 0 are stored as the edition-number information at the time of the search corresponding to the page numbers 2 and 3. Referring to FIG. 5A again, in the AI server 14-1, editing operations for update records are performed while the screen display of the retrieved records is viewed in step S104, and a record update is requested to the host 10 for the edited records in step S105. The host 10 checks reception of the record update request in step S9 and, when the update request is received, the exclusive lock is set to the update-target pages to initiate a transaction in step S10. If the AI server 14-1 requests the record update for the both search-target pages 22-2 and 22-3, by respectively setting the exclusive flags to 1 for the page numbers 2 and 3 of the exclusive lock management table 32 of FIG. 4, the exclusive lock is set for occupation. Then, in step S11, the current numbers of the update-target pages are obtained from the edition number management table 30. It is assumed that, in the contents of the edition number management table 30 at this time, although the page number 2 has the initial value 0, the page number 3 has been updated to 1 as shown in FIG. 6B. Subsequently, in step S12, the edition numbers at the time of the search are obtained from the edition number storage table 42 of the AI server 14-1. The edition numbers at the time of the search are 0 for the page numbers 2 and 3 as shown in FIG. 6A. Subsequently, in step S13, it is decided whether the current edition numbers are identical to the edition numbers at the time of the search. For the page number 2 of the page 22-2, since the both edition numbers are 0, these edition numbers are identical; in this case, the operation proceeds to step S14 to target the page 22-2 for updating the records included therein; then, the operation proceeds to step S15 of FIGS. 5B and 5C to notify the AI server 14-1 of completion of the update; and in response to this, in step S107, the AI server 14-1 displays the completion of update and terminates the series of processing. On the other hand, when the current edition number is compared to the edition number at the time of the search for the page 22-3 in step S13 of FIG. 5A, since these edition numbers are not identical, the operation proceeds to step S16 of FIGS. 5B and 5C to cancel the update processing request for the page 22-3, and in step S17, the AI server 14-1 is notified of the error notification which has contents for a search retry. Then, in step S18, the exclusive lock is released to terminate the transaction of the record update. In the AI server 14-1, the update error is displayed based on the error notification from the host 10 in step S108, and a retry from the search processing will be performed in step s109.

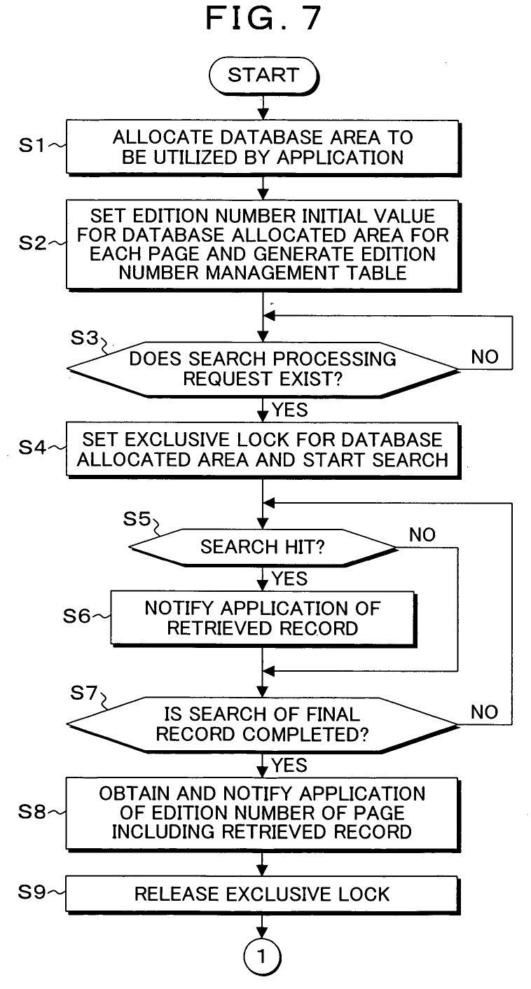

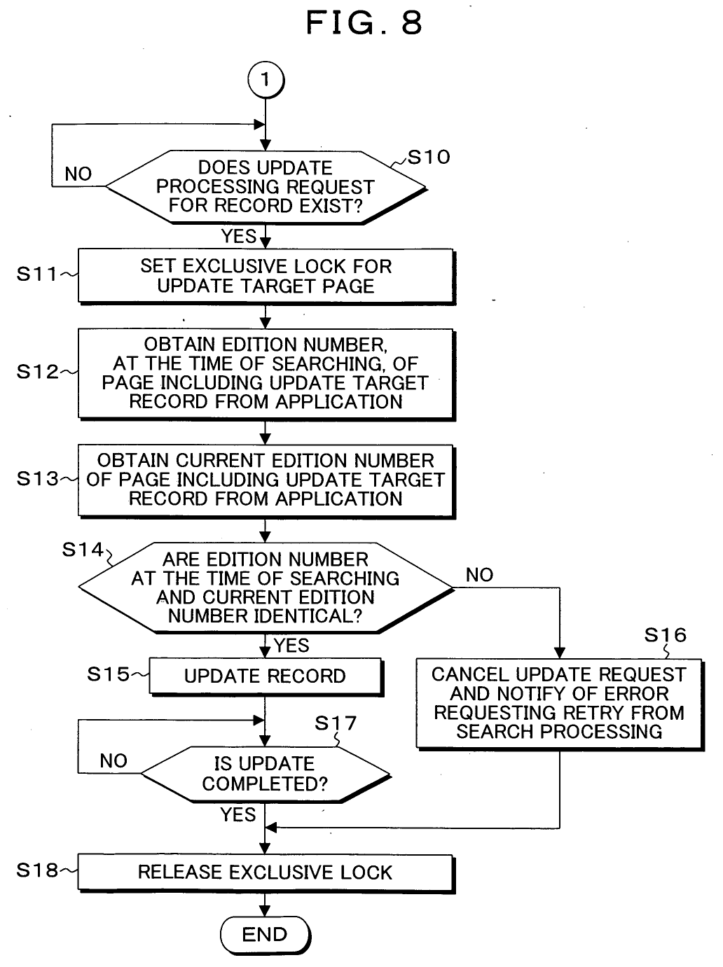

FIG. 7 and FIG. 8 are flowcharts of database management processing of the database management unit 18 provided in the host 10 of FIG. 1, according to the present invention. In FIG. 7, the database management processing is initiated by start of a job in the database management unit 18 and, in step 1, an available database area, i.e., a page area is allocated for each of the AI servers 14-1 to 14-3 connected as a database connector to the host 10. Then, in step S2, an edition number initial value 0 is set for each page of the database allocated area to generate the edition number management table 30. Subsequently, in step S3, it is checked whether a search processing request from the AI server side exists or not and, if the search processing request exists, the operation proceeds to step S4 to exclusively lock the database allocated area and then initiate the search processing. Of course, if an exclusive lock has been applied by other transactions, after waiting for release thereof, the exclusive lock will be applied. Subsequently, it is checked whether a search hit exists or not for each record; if the search hit exists, the application is notified of the retrieved records in step S6; it is checked whether the search is completed for the final record in the allocated area or not in step S7; and the processing from step S5 is repeated until the search is completed for the final record. When the search is completed for the final record in the allocated area, in step S8, for the pages including the retrieved records, edition numbers are obtained from the edition number management table 30 and the application is notified of the edition numbers. Subsequently, in step S9, the exclusive lock is released to terminate the transaction of the search processing. In step S10, it is checked whether a record update processing request exists or not and, if it is decided that the update processing request exists, after the exclusive lock is applied to the pages including the update-target records in step S11, the edition numbers at the time of the search are obtained from the application for the pages including the update-target records in step 12. Subsequently, in step S13, the current edition numbers are obtained from the edition number management table 30 for the pages including the update-target records. In step S14, it is compared and decided whether the current edition numbers are identical to the edition number at the time of the search and, if the edition numbers are identical, the exclusive lock is applied to the pages including the search-target records to update the records in step S15. Then, if it is decided that the update is completed in step S17, the exclusive lock is released in step S18 to terminate the record update. On the other hand, if the current edition number is not identical to the edition number at the time of the search in step S14, the operation proceeds to step S16; the update request is canceled; the application is notified of the error notification requesting a retry from the search processing; and in step S18, the exclusive lock is released to terminate the series of processing. Also, the present invention provides a database management program acting as the database management unit 18 provided in the host 10 of FIG. 1 and the database management program is provided with procedures shown in the flowcharts of FIGS. 7 and 8 as contents of the program. Further, the database management program of the present invention is executed in a hardware environment of a computer constituting the host 10. In the computer constituting the host 10 of FIG. 1, a CPU bus is connected to RAM, a hard disc controller (software), a floppy disk driver (software), a CD-ROM driver (software), a mouse controller, a keyboard controller, a display controller and a communication board. The hard disk controller connects a hard disk drive to load programs for executing the database management processing of the present invention, and on startup of the computer, necessary programs are called from the hard disk drive, deployed on the RAM and executed by the CPU. Although, in the above embodiment, if the update targets are multiple records included in multiple pages, an update is performed for a page with the current edition number identical to the edition number at the time of the search and an error notification is performed for a page with the edition numbers which are not identical, the error notification may be performed for all the update-target pages without updating if the edition number of a portion of the update-target pages are not identical, and the retry processing may be performed from the search. The present invention encompasses any modifications without impairing the object and benefit thereof and is not limited by the numerical values indicated in the above embodiments.

1. A database management program operable to drive a host computer managing a database to execute:
an edition number management step of registering and managing an edition number of each minimum unit for exclusively controlling the database, and updating the corresponding edition number in accordance with updating processing within the minimum unit;
a search step of executing database search processing when a search processing request for the database is received, notifying a search-processing request source of search results, and notifying the search-processing request source of edition numbers of the minimum units corresponding to all the search results for storage; and
an update step of, when a database update-processing request is received based on the notification of the search results, comparing edition numbers at the time of the search obtained from the update-processing request source with current edition numbers managed by the edition number management step, updating the database if the both edition numbers are identical and notifying of an error if the both edition numbers are not identical.

2. The database management program of claim 1, wherein
the minimum unit for exclusively controlling the database is a page unit including multiple records, and the edition number management step registers and manages the edition number of each page for exclusively controlling the database and updates the corresponding edition number in accordance with the record update processing within the page, wherein
the search step executes the database search processing when a record search request for the database is received, notifies the request source of search results, and notifies the request source of edition numbers of the pages corresponding to the retrieved records for storage, and wherein
when a record update request is received based on the notification of the retrieved records, the update step compares edition numbers at the time of the search obtained from the update request source with current edition numbers managed by the edition number management step, updates the database if the both edition numbers are identical and notifies of an error if the both edition numbers are not identical.

3. The database management program of claim 1, wherein
the search step sets an exclusive lock to a search-target area of the database specified by a minimum unit of the exclusive control when the search is initiated and releases the exclusive lock when the search is terminated, and wherein
the update step sets an exclusive lock to a update-target area of the database which is a minimum unit of the exclusive control including update-target data when the update is initiated and releases the exclusive lock when the update is terminated.

4. The database management program of claim 1, wherein the update step receives the database update-processing request after a time lag due to human operations from the notification of the search results.

5. The program of claim 1, wherein the edition number management step sets an initial value of an edition number for each minimum unit controlled exclusively, targeting a database area allocated to the search request source, and increments the edition number by 1 every time the update processing is performed.

6. The database management program of claim 1, wherein, as the error notification, the search step notifies of a retry request from the search processing.

7. The database management program of claim 1, wherein the database is a basic database of the host, and wherein the request source of the search processing and of the update processing is an application on a server.

8. A database management method comprising:
an edition number management step of registering and managing an edition number of each minimum unit for exclusively controlling the database, and updating the corresponding edition number in accordance with updating processing within the minimum unit;
a search step of executing database search processing when a search processing request for the database is received, notifying a search-processing request source of search results, and notifying the search-processing request source of edition numbers of the minimum units corresponding to all the search results for storage; and
an update step of, when a database update-processing request is received based on the notification of the search results, comparing edition numbers at the time of the search obtained from the update-processing request source with current edition numbers managed by the edition number management step, updating the database if the both edition numbers are identical and notifying of an error if the both edition numbers are not identical.

9. A database management apparatus comprising:
an edition number management unit registering and managing an edition number of each minimum unit for exclusively controlling the database, and updating the corresponding edition number in accordance with updating processing within the minimum unit;
a search unit executing database search processing when a search processing request for the database is received, notifying a search-processing request source of search results, and notifying the search-processing request source of edition numbers of the minimum units corresponding to all the search results for storage; and
an update unit, when a database update-processing request is received based on the notification of the search results, comparing edition numbers at the time of the search obtained from the update-processing request source with current edition numbers managed by the edition number management step, updating the database if the both edition numbers are identical and notifying of an error if the both edition numbers are not identical.

10. A computer readable recording medium having therein stored a database management program operable to drive a host computer managing a database to execute:
an edition number management step of registering and managing an edition number of each minimum unit for exclusively controlling the database, and updating the corresponding edition number in accordance with updating processing within the minimum unit;
a search step of executing database search processing when a search processing request for the database is received, notifying a search-processing request source of search results, and notifying the search-processing request source of edition numbers of the minimum units corresponding to all the search results for storage; and
an update step of, when a database update-processing request is received based on the notification of the search results, comparing edition numbers at the time of the search obtained from the update-processing request source with current edition numbers managed by the edition number management step, updating the database if the both edition numbers are identical and notifying of an error if the both edition numbers are not identical.
